(19) United States
(12) Patent Application Publication
(10) Pub. No.: US 2024/0128430 A1
(43) Pub. Date: Apr. 18, 2024

(54) ELECTRODE BODY AND BATTERY

(71) Applicant: TOYOTA JIDOSHA KABUSHIKI KAISHA, Toyota-shi Aichi-ken (JP)

(72) Inventors: Noriyuki Kato, Nagoya-shi Aichi-ken (JP); Katsushi Enokihara, Toyota-shi Aichi-ken (JP); Kiminori Unno, Hamamatsu-shi Shizuoka-ken (JP); Kenji Koura, Toyota-shi Aichi-ken (JP); Takeshi Kondo, Kariya-shi Aichi-ken (JP)

(73) Assignee: TOYOTA JIDOSHA KABUSHIKI KAISHA, Toyota-shi Aichi-ken (JP)

(21) Appl. No.: 18/377,043

(22) Filed: Oct. 5, 2023

(30) Foreign Application Priority Data
Oct. 13, 2022 (JP) 2022-164662

(51) Int. Cl. H01M 4/04

(52) U.S. Cl. CPC H01M 4/0404; H01M 2004/025

(57) ABSTRACT

An electrode body including a current collector and an electrode layer that includes layers in the order of a first electrode layer and a second electrode layer from the current collector side in a thickness direction. The first electrode layer includes an end surface A, and the second electrode layer includes an end surface B. In a cross-sectional view in the thickness direction, the end surface A includes an end part A₁ in the current collector side, and an end part A₂ in the second electrode layer side, and the end surface B includes an end part B₁ in the first electrode layer side, and an end part B₂ in an opposite side to the first electrode layer; the end surface A includes, in a vertical direction to the thickness direction, and a first inclination part in which the end part A₁ protrudes form the end part A₂.

### CROSS-REFERENCE TO RELATED APPLICATIONS

This application is based upon and claims the benefit of priority of the prior Japanese Patent Application No. 2022-164662, filed on Oct. 13, 2022, the entire contents of which are incorporated herein by reference.

### TECHNICAL FIELD

The present disclosure relates to an electrode body and a battery.

### BACKGROUND ART

A battery such as a lithium ion secondary battery is provided with an electrode body including a current collector, and an electrode layer containing an active material. For example, Patent Literature 1 discloses a lithium ion secondary battery including a current collecting foil as a current collector, and an electrode film in which a plurality of electrode film layers are layered. Patent Literature 1 discloses that the lithium ion secondary battery includes, in the electrode film layers, a layer with higher concentration of a binder in the current collecting foil side, compared to that of the opposite side of the current collecting foil.

Patent Literature 2 discloses a production method of an electrode for secondary battery, the method including a step of pasting a slurry for first layer on a surface of a current collector, and a step of pasting a slurry for second layer on the slurry for first layer before the slurry for first layer is dried. Patent Literature 2 discloses that a first binder used for the slurry for first layer has higher viscosity than that of a second binder used for the slurry for second layer.

Patent Literature 3 discloses an electrode for lithium ion secondary battery including a current collector, and an electrode layer that is formed on a surface of the current collector and includes a binder resin, an active material and a conductive auxiliary material. Patent Literature 3 discloses that the electrode layer includes a first electrode layer, and a second electrode layer of which binder resin concentration is higher than that of the first electrode layer. Also, although it is not a technique related to an electrode, Patent Literature 4 discloses a separation film including a base material, a first layer including a LFP particle and a first binder, and a second layer including an organic particle and a second binder.

### CITATION LIST

### Patent Literatures

Patent Literature 1: Japanese Patent Application Laid-Open (JP-A) No. 2014-107182
Patent Literature 2: JP-A No. 2019-096501
Patent Literature 3: International Application Publication: WO 2011/142083
Patent Literature 4: JP-A No. 2020-136276

### SUMMARY OF DISCLOSURE

### Technical Problem

For example, Patent Literature 2 discloses that an electrode layer is produced by pasting a slurry on the surface of a current collector. When the slurry is pasted on the current collector, an end surface of the coating layer (electrode layer before drying) inclines (sags) due to the fluidity of the slurry. In the inclined end surface, a defect such as a crack easily occurs. In particular, the thicker the coating layer is, the larger the inclination amount (sagging amount) becomes, and it is difficult to inhibit the occurrence of the defect.

The present disclosure has been made in view of the above circumstances and a main object thereof is to provide an electrode body in which occurrence of defect in an end surface of an electrode layer is inhibited.

### Solution to Problem

[1]

An electrode body to be used for a battery, the electrode body comprising:
a current collector and an electrode layer, wherein
the electrode layer includes layers in the order of a first electrode layer and a second electrode layer from the current collector side in a thickness direction;
the first electrode layer includes an end surface A, and the second electrode layer includes an end surface B;
in a cross-sectional view in the thickness direction, the end surface A includes an end part A₁ in the current collector side, and an end part A₂ in the second electrode layer side, and the end surface B includes an end part B₁ in the first electrode layer side, and an end part B₂ in an opposite side to the first electrode layer;
the end surface A includes, in a vertical direction to the thickness direction, a first inclination part in which the end part A₁ protrudes from the end part A₂; and
when the electrode body is viewed from the thickness direction, an entire outer periphery of the second electrode layer is arranged inside an entire outer periphery of the first electrode layer.

[2]

The electrode body according to [1], wherein
the end surface B includes a second inclination part in which the end part B₁ protrudes from the end part B₂ in the vertical direction to the thickness direction; and
in the cross-sectional view of the thickness direction, the first inclination part is arranged outside the second inclination part.

[3]

The electrode body according to [1] or [2], wherein, when the electrode body is viewed from the thickness direction, the first inclination part is arranged along with the entire outer periphery of the first electrode layer, and the second inclination part is arranged along with the entire outer periphery of the second electrode layer.

[4]

The electrode body according to any one of [1] to [3], wherein the electrode body includes an exposed part where the first electrode layer is exposed from the second electrode layer, since the end part A₂ protrudes from the end part B₁ in the vertical direction to the thickness direction.

[5]

The electrode body according to [4], wherein, when the electrode body is viewed from the thickness direction, the exposed part is arranged along with the entire outer periphery of the first electrode layer interposing the first inclination part.

[6]

The electrode body according to [1] or [2], wherein the end part A₂ in the end surface A is a tip T₁ of a protrusion that extends in the thickness direction; and
in the cross-sectional view of the thickness direction, an end part B₃ corresponding to the outer periphery of the second electrode layer is arranged inside the tip T₁.

[7]

The electrode body according to [6], wherein, when the electrode body is viewed from the thickness direction, the entire outer periphery of the second electrode layer is arranged inside the entire periphery of the tip T₁.

[8]

The electrode body according to any one of [1] to [7], wherein a thickness of the second electrode layer is larger than a thickness of the first electrode layer.

[9]

The electrode body according to any one of [1] to [8], wherein a thickness of the electrode layer is 200 μm or more.

[10]

The electrode body according to any one of [1] to [9], wherein each of the first electrode layer and the second electrode layer contains a binder; and
a proportion of the binder in the first electrode layer is more than a proportion of the binder in the second electrode layer.

[11]

A battery including the electrode body according to any one of [1] to [10].

### Effects of Disclosure

The electrode body in the present disclosure exhibits an effect of inhibiting occurrence of defect in an end surface of an electrode layer.

### BRIEF DESCRIPTION OF DRAWINGS

FIG. 1A is a schematic plan view exemplifying the electrode body in the present disclosure.

FIG. 1B is a schematic a cross-sectional view exemplifying the electrode body in the present disclosure.

FIG. 2A is a schematic cross-sectional view exemplifying the electrode body in the present disclosure.

FIG. 2B is another schematic cross-sectional view exemplifying the electrode body in the present disclosure.

FIG. 2C is still another schematic cross-sectional view exemplifying the electrode body in the present disclosure.

FIG. 2D is still another schematic cross-sectional view exemplifying the electrode body in the present disclosure.

FIG. 3A is a schematic cross-sectional view exemplifying the electrode body in the present disclosure.

FIG. 3B is another schematic cross-sectional view exemplifying the electrode body in the present disclosure.

FIG. 4A is a schematic plan view exemplifying the electrode body in the present disclosure.

FIG. 4B is a schematic cross-sectional view exemplifying the electrode body in the present disclosure.

FIG. 5A is a schematic cross-sectional view exemplifying the electrode body in the present disclosure.

FIG. 5B is another schematic cross-sectional view exemplifying the electrode body in the present disclosure.

FIG. 5C is still another schematic cross-sectional view exemplifying the electrode body in the present disclosure.

FIG. 5D is still another schematic cross-sectional view exemplifying the electrode body in the present disclosure.

FIG. 6 is a schematic cross-sectional view explaining the production method of an electrode body in the present disclosure.

FIG. 7 is a schematic cross-sectional view exemplifying the battery in the present disclosure.

### DESCRIPTION OF EMBODIMENTS

The embodiments in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

A. Electrode Body

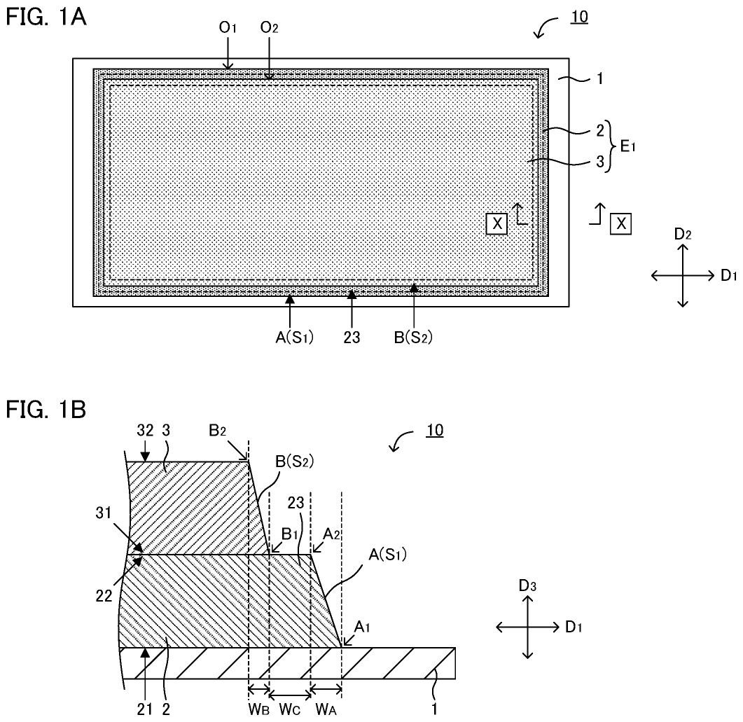

FIG. 1A is a schematic plan view exemplifying the electrode body in the present disclosure, and FIG. 1B is a cross-sectional view of X-X in FIG. 1A. As shown in FIG. 1A and FIG. 1B, electrode body 10 includes current collector 1 and electrode layer E₁ arranged on the current collector 1. The electrode layer E₁ includes layers in the order of first electrode layer 2 and second electrode layer 3 from the current collector 1 side in thickness direction D₃. Also, as shown in FIG. 1B, the first electrode layer 2 includes an end surface A, and the second electrode layer 3 includes an end surface B.

As shown in FIG. 1B, in the cross-sectional view of the thickness direction D₃, the end surface A includes end part A₁ in the current collector 1 side, and end part A₂ in the second electrode layer 3 side. Also, the end surface B includes end part B₁ in the first electrode layer 2 side, and end part B₂ in the opposite side to the first electrode layer 2 side. Also, the end surface A includes, in vertical direction D₁ to the thickness direction D₃, first inclination part S₁ in which the end part A₁ protrudes from the end part A₂. Also, as shown in FIG. 1A, when the electrode body 10 is viewed from the thickness direction, entire outer periphery O₂ of the second electrode layer 3 is arranged inside entire outer periphery O₁ of the first electrode layer 2. In FIG. 1A and FIG. 1B, the outer periphery O₁ of the first electrode layer 2 is specified by the end part A₁ in the end surface A, and the outer periphery O₂ of the second electrode layer 3 is specified by the end part B₁ in the end surface B.

According to the present disclosure, since the electrode layer includes the first electrode layer and the second electrode layer, and further since the entire outer periphery of the second electrode layer is arranged inside the entire outer periphery of the first electrode layer, occurrence of defect in the end surface of the electrode layer is inhibited in the electrode body. As described above, for example, Patent Literature 2 discloses that an electrode layer is produced by pasting a slurry on a surface of a current collector. When the slurry is pasted on the current collector, an end surface of the coating layer (electrode layer before drying) inclines (sags) due to the fluidity of the slurry. In the inclined end surface, a defect such as a crack easily occurs. In particular, the thicker the coating layer is, the larger the inclination amount (sagging amount) becomes, and it is difficult to inhibit the occurrence of the defect.

In contrast, the electrode layer in the present disclosure includes the first electrode layer and the second electrode layer. For this reason, when the first electrode layer and the second electrode layer are produced, the shape of the end surface of the first electrode layer and the shape of the end surface of the second electrode layer can be minutely controlled. As a result, for example when electrode layers in the same thickness are produced, compared to when the electrode layer is a single layer of just the first electrode layer, occurrence of defect in the end surface of the electrode layer can be inhibited.

Further, since the entire outer periphery of the second electrode layer is arranged inside the entire outer periphery of the first electrode layer, excessive inclination amount (sagging amount) in the end surface of the second electrode layer can be inhibited. As a result, occurrence of defect in the end surface of the second electrode layer can be inhibited. Also, by inhibiting the excessive inclination amount (sagging amount) in the end surface of the electrode layer, decrease of a valid area of the electrode layer can be inhibited, and thus an electrode body with high capacity can be obtained.

Also, when the inclination amount (sagging amount) of the end surface of the electrode layer is too small, a corner of the electrode layer is easily peeled off when the electrode layer is carried and when the electrode layer is pressed. In contrast, in the present disclosure, since the first electrode layer and the second electrode layer respectively include the end surface A and the end surface B, the inclination amount (sagging amount) of the end surface of the electrode layer can be prevented from decreasing too much, and thus the peel-off of the corner of the electrode layer can be inhibited.

1. Constitution of Electrode Body

The electrode body in the present disclosure includes a current collector and an electrode layer.

(1) Current Collector

The shape of the current collector in a plan view (shape viewed from the thickness direction) is not particularly limited, and examples thereof may include a square shape such as a rectangular shape and a foursquare shape. For example, the shape of the current collector 1 shown in FIG. 1A in a plan view is a rectangular shape, and the first direction D₁ corresponds to a longer direction, and the second direction D₂ (a direction orthogonal to the first direction D₁) corresponds to a shorter direction. The first direction D₁ corresponds to, for example, a carrying direction of the current collector 1 when the electrode body is produced.

(2) Electrode Layer

The shape of the electrode layer in a plan view is not particularly limited, and examples thereof may include a square shape such as a rectangular shape and a foursquare shape. The shape of the electrode layer E₁ shown in FIG. 1A in a plan view is a rectangular shape, and the first direction D₁ corresponds to a longer direction, and the second direction D₂ corresponds to a shorter direction.

As shown in FIG. 1A and FIG. 1B, the electrode layer E₁ includes layers in the order of first electrode layer 2 and second electrode layer 3 from the current collector 1 side in thickness direction D₃. In other words, the first electrode layer 2 is arranged on the current collector 1, and the second electrode layer 3 is arranged on the first electrode layer 2. The thickness direction D₃ is a direction corresponding to the thickness of the electrode body, and it is usually orthogonal to the first direction D₁ and the second direction D₂.

As shown in FIG. 1B, the first electrode layer 2 includes main surface 21 in the current collector 1 side, and main surface 22 in the second electrode layer 3 side. The second electrode layer 3 includes main surface 31 in the first electrode layer 2 side, and main surface 32 opposite the main surface 31. The end surface A in the first electrode layer 2 is a side surface that connects the main surface 21 and the main surface 22. The end surface A is arranged along with the entire outer periphery of the main surface 21 and the entire outer periphery of the main surface 22.

As shown in FIG. 1B, the end surface A includes, in vertical direction D₁ to the thickness direction D₃, first inclination part S₁ in which the end part A₁ protrudes from the end part A₂. The inclination part S₁ is typically a part generated due to the fluidity of slurry when the first electrode layer 2 is produced. In FIG. 1B, the end surface A in the first direction D₁ includes the first inclination part S₁. Although not illustrated, in the first direction D₁, facing two of the end surface A may respectively include the first inclination part S₁. Also, as shown in FIG. 1A, the end surface A in the second direction D₂ may include the first inclination part S₁. Although not illustrated, in the second direction D₂, facing two of the end surface A may respectively include the first inclination part S₁.

As shown in FIG. 1A, when the electrode body 10 is viewed from the thickness direction, the first inclination part S₁ may be arranged along with the entire outer periphery O₁ of the first electrode layer 2. In this case, the outer periphery O₁ is specified by the end part A₁ in the end surface A, and the first inclination part S₁ is arranged inside the outer periphery O₁.

As shown in FIG. 1A, when the electrode body 10 is viewed from the thickness direction, the entire outer periphery O₂ of the second electrode layer 3 is arranged inside the entire outer periphery O₁ of the first electrode layer 2. Thereby, occurrence of defect in the end surface of the electrode layer can be inhibited.

As shown in FIG. 1B, the end surface B may include second inclination part S₂ in which the end part B₁ protrudes from the end part B₂ in the vertical direction D₁ to the thickness direction D₃. The second inclination part S₂ is typically a part generated due to the fluidity of slurry when the second electrode layer 3 is produced. In FIG. 1B, the end surface B in the first direction D₁ includes the second inclination part S₂. Although not illustrated, in the first direction D₁, facing two of the end surface B may respectively include the second inclination part S₂. Also, as shown in FIG. 1A, the end surface B in the second direction D₂ may include the inclination part S₂. Although not illustrated, in the second direction D₂, facing two of the end surface B may respectively include the second inclination part S₂.

As shown in FIG. 1A, when the electrode body 10 is viewed from the thickness direction, the second inclination part S₂ may be arranged along with the entire outer periphery O₂ of the second electrode layer 3. In this case, the outer periphery O₂ is specified by the end part B₁ in the end surface B, and the second inclination part S₂ is arranged inside the outer periphery O₂.

In some embodiments, in the cross-sectional view of the thickness direction D₃, the first inclination part S₁ is arranged outside the second inclination part S₂. For example, in FIG. 1B, in the first direction D₁, the first inclination part S₁ is entirely arranged outside the second inclination part S₂.

As shown in FIG. 1B, the electrode body 10 may include exposed part 23. The exposed part 23 is a part where the first electrode layer 2 is exposed from the second electrode layer 3, since the end part A₂ protrudes from the end part B₁ in the vertical direction D₁ to the thickness direction D₃. In FIG. 1B, the exposed part 23 is arranged between the end surface A and the end surface B in the first direction D₁. Although not illustrated, the exposed part 23 may be arranged respectively in the both end surfaces of the electrode body 10 in the first direction D₁. Also, as shown in FIG. 1A, the exposed part 23 may be arranged between the end surface A and the end surface B in the second direction D₂. Although not illustrated, the exposed part 23 may be arranged respectively in the both end surfaces of the electrode body 10 in the second direction D₂. Also, as shown in FIG. 1A, when the electrode body 10 is viewed from the thickness direction, the exposed part 23 may be arranged along with the entire outer periphery O₁ of the first electrode layer 2 interposing the first inclination part S₁.

As shown in FIG. 1B, W_{A} designates the width of the first inclination part S₁, W_{B} designates the width of the second inclination part S₂, and W_{C} designates the width of the exposed part 23. The W_{A} is, for example, 0.1 mm or more and 10 mm or less, and may be 0.5 mm or more and 2 mm or less. The W_{B} is, for example, 0.1 mm or more and 10 mm or less, and may be 0.5 mm or more and 2 mm or less. The W_{C} is, for example, 0.1 mm or more and 10 mm or less, and may be 0.1 mm or more and 2 mm or less.

There are not particular limitations on the relation between the thickness of the first electrode layer and the thickness of the second electrode layer. The thickness of the both may be the same and may be different. “The thickness of the first electrode layer and the thickness of the second electrode layer being same” means that the difference in the thickness of the both is 10 μm or less.

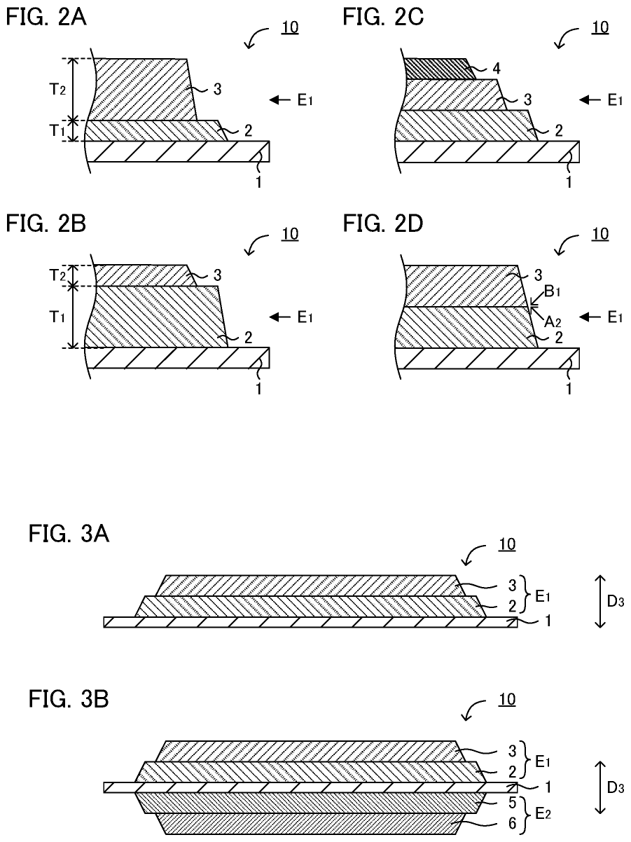

As shown in FIG. 2A, the thickness T₂ of the second electrode layer 3 may be larger than the thickness T₁ of the first electrode layer 2. In this case, the rate of T₂ with respect to T₁, which is T₂/T₁ is larger than 1, and may be 1.5 or more. Meanwhile, the T₂/T₁ is, for example, 10 or less, and may be 5 or less.

As shown in FIG. 2B, the thickness T₂ of the second electrode layer 3 may be smaller than the thickness T₁ of the first electrode layer 2. In this case, the rate of T₂ with respect to T₁, which is T₂/T₁ is smaller than 1, may be 0.9 or less, and may be 0.5 or less. Meanwhile, the T₂/T₁ is, for example, 0.1 or more.

The electrode layer in the present disclosure includes at least a first electrode layer and a second electrode layer. As shown in FIG. 2A, electrode layer E₁ may include just first electrode layer 2 and second electrode layer 3. Meanwhile, as shown in FIG. 2C, the electrode layer E₁ may include an additional electrode layer 4 in addition to the first electrode layer 2 and the second electrode layer 3. The additional electrode layer 4 may be a single layer, and may be a plurality of layers.

The thickness T₁ of the first electrode layer 2 is, for example, 50 μm or more and 500 μm or less. The thickness T₂ of the second electrode layer 3 is, for example, 50 μm or more and 500 μm or less. Also, the thickness of the electrode layer E₁ is, for example, 200 μm or more, may be 400 μm or more, and may be 600 μm or more. Meanwhile, the thickness of the electrode layer E₁ is, for example, 1000 μm or less.

As shown in FIG. 2D, the electrode body 10 may not include the above described exposed part (such as exposed part 23 in FIG. 1B). In FIG. 2D, the position of the end part A₂ in the first electrode layer 2 matches the position of the end part B₁ in the second electrode layer 3.

Each of the first electrode layer and the second electrode layer may contain a binder. In that case, there are no particular limitations on the relation between the proportion (weight %) of the binder in the first electrode layer and the proportion (weight %) of the binder in the second electrode layer. The proportion of the both may be the same and may be different. “The proportion (weight %) of the binder in the first electrode layer and the proportion (weight %) of the binder in the second electrode layer being the same” means that the difference of the proportion between the both is 1% or less.

The proportion (weight %) of the binder in the first electrode layer is regarded as C₁, and the proportion (weight %) of the binder in the second electrode layer is regarded as C₂. When C₁>C₂, the rate of C₁ with respect to C₂, which is C₁/C₂ is, for example, 3 or more, and may be 5 or more. Meanwhile, the C₁/C₂ is, for example, 10 or less. Also, when C₁>C₂, there are no particular limitations on the relation of the above described thickness, and it may be T₂>T₁, may be T₂=T₁, and may be T₂<T₁.

When C₁<C₂, the rate of C₁ with respect to C₂, which is C₁/C₂ is, for example, 0.9 or less, and may be 0.8 or less. Meanwhile, the C₁/C₂ is, for example, 0.1 or more. Also, when C₁<C₂, there are no particular limitations on the relation of the above described thickness, and it may be T₂>T₁, may be T₂=T₁, and may be T₂<T₁. Incidentally, also when C₁=C₂, there are no particular limitations on the relation of the above described thickness, and it may be T₂>T₁, may be T₂=T₁, and may be T₂<T₁.

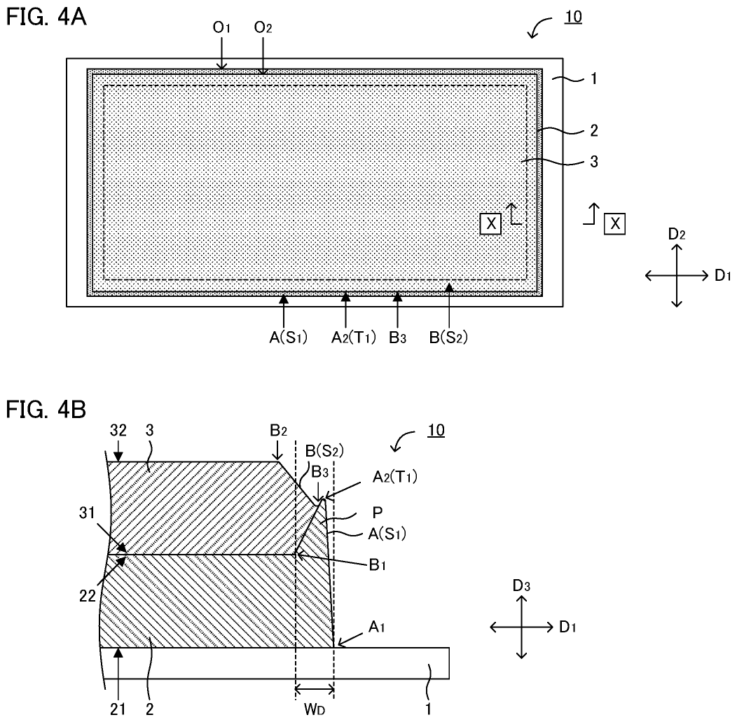

As shown in FIG. 3A, the electrode body 10 may include electrode layer E₁ on one surface of current collector 1, and may not include an electrode layer on the other surface of the current collector 1. Also, as shown in FIG. 3B, the electrode body 10 may include the electrode layer E₁ on one surface of the current collector 1, and may include electrode layer E₂ on the other surface of the current collector 1. The electrode layer E₂ may be a single layer, and may be a plurality of layers. For example, the electrode layer E₂ in FIG. 3B includes layers in the order of third electrode layer 5 and fourth electrode layer 6 from the current collector 1 side. The electrode layer E₁ and the electrode layer E₂ may have the same polarity and may have opposite polarities. In the former case, the electrode layer E₁ and the electrode layer E₂ may be a cathode layer, and the electrode layer E₁ and the electrode layer E₂ may be an anode layer. In the latter case, the electrode layer E₁ may be a cathode layer and the electrode layer E₂ may be an anode layer, and the electrode layer E₁ may be an anode layer and the electrode layer E₂ may be a cathode layer. The details of the electrode layer E₂ are in the same contents as those described for the electrode layer E₁ described above. The third electrode layer may have the same characteristics of the first electrode layer described above. Also, the fourth electrode layer may have the same characteristics of the second electrode layer described above.

<Variation>

A variation of the electrode layer in the present disclosure is as follows. In some embodiments, the end part A₂ in the end surface A is the tip T₁ of the protrusion extending to the thickness direction, and the end part B₃ corresponding to the outer periphery of the second electrode layer in the cross-sectional view of the thickness direction is arranged inside the tip T₁. Incidentally, characteristics of the variation are in the same contents as those described above except for the arrangement of the protrusion.

FIG. 4A is a schematic plan view exemplifying the electrode body in the present disclosure, and FIG. 4B is a cross-sectional view of X-X in FIG. 4A. As shown in FIG. 4B, in some embodiments, the end part A₂ in the end surface A is the tip T₁ of the protrusion P extending to the thickness direction D₃, and the end part B₃ corresponding to the outer periphery O₂ of the second electrode layer 3 in the cross-sectional view of the thickness direction D₃ is arranged inside the tip T₁.

As shown in FIG. 4B, the end part B₃ corresponding to the outer periphery O₂ of the second electrode layer 3 in the first direction D₁ may be arranged inside the tip T₁. Although not illustrated, in the first direction D₁, facing two of the end part B₃ may be respectively arranged inside the tip T₁. Also, as shown in FIG. 4A, in the second direction D₂, the end part B₃ corresponding to the outer periphery O₂ of the second electrode layer 3 may be arranged inside the tip T₁. Although not illustrated, in the second direction D₂, facing tow of the end part B₃ may be respectively arranged inside the tip T₁. Also, as shown in FIG. 4A, when the electrode body 10 is viewed from the thickness direction, the tip T₁ may be arranged along with the entire outer periphery O₁ of the first electrode layer 2. Further, the entire outer periphery O₂ of the second electrode layer 3 may be arranged inside the entire tip T₁.

As shown in FIG. 4B, W_{D} designates the width of protrusion P. The W_{D} is, for example, 0.1 mm or more and 10 mm or less, and may be 1 mm or more and 3 mm or less.

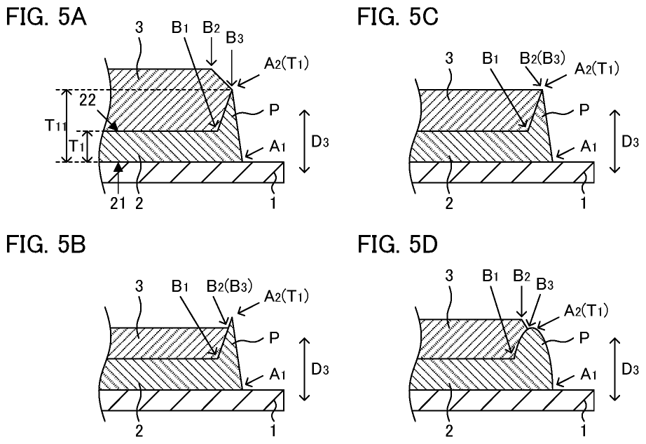

As shown in FIG. 5A, T₁ designates the thickness of the first electrode layer 2, and T₁ designates the thickness of protrusion P. The T₁ is a thickness of a flat surface other than the protrusion P, and in specific, it is a distance of the main surface 21 and the main surface 22 in the first electrode layer 2 (distance in the thickness direction D₃). Meanwhile, the T₁ is a distance of the main surface 21 and the tip T₁ of the protrusion P in the first electrode layer 2 (distance in the thickness direction D₃). The rate of T₁₁ with respect to T₁, which is T₁₁/T₁ is, for example, 1.1 or more and may be 1.3 or more. Meanwhile, the T₁₁/T₁ is, for example, 2 or less, and may be 1.8 or less.

As shown in FIG. 5A, the end part B₂ may protrudes from the tip T₁ of the protrusion P in the thickness direction D₃. In this case, usually, the end part B₃ is arranged outside (right side in the drawing) the end part B₂.

As shown in FIG. 5B, the tip T₁ of the protrusion P may protrudes from the tip B₂ in the thickness direction D₃. Also, as shown in FIG. 5C, the position of the tip T₁ of the protrusion P may match the position of the end part B₂. In these cases, the end part B₂ matches the end part B₃. Also, as shown in FIG. 5D, the tip T₁ of the protrusion P may be in a curved line shape.

2. Member of Electrode Body

The electrode body in the present disclosure includes a current collector, and an electrode layer arranged on the current collector. Examples of the material for the current collector may include a metal material such as aluminum, copper, SUS, and nickel. Examples of the shape of the current collector may include a foil shape.

The electrode layer contains at least an active material. The electrode layer may contain a cathode active electrode, and may contain an anode active material, as the active material. Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li(Ni_{0.5}Mn_{1.5})O₄; and an olivine type active material such as LiFePO₄, LiMnPO₄, LiNiPO₄, and LiCoPO₄. Meanwhile, examples of the anode active material may include a Li-based active material such as Li and a Li alloy, a carbon active material such as graphite, and a Si-based active material such as Si and SiO.

The electrode layer may contain a conductive material. Examples of the conductive material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF). The electrode layer may contain just one kind of the conductive material, and may contain two kinds or more thereof.

The electrode layer may contain a binder. Examples of the binder may include a cellulose-based binder such as carboxymethylcellulose (CMC), a rubber-based binder such as styrene butadiene rubber (SBR), and a fluorine-based binder such as polyvinylidene fluoride (PVDF). The electrode layer may contain just one kind of the binder, and may contain two kinds or more thereof.

3. Production Method of Electrode Body

The present disclosure can provide a production method of an electrode body, the electrode body described above, the method including a first coating layer forming step of forming a first coating layer by coating the current collector with a first slurry, a second coating layer forming step of forming a second coating layer by coating the first coating layer with a second slurry, and a drying step of drying the first coating layer and the second coating layer to form the first electrode layer and the second electrode layer.

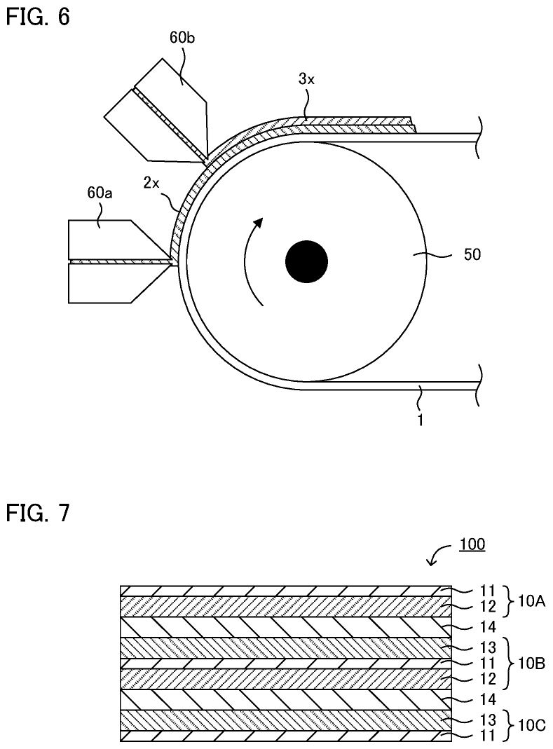

FIG. 6 is a schematic cross-sectional view explaining the production method of the electrode body in the present disclosure. As shown in FIG. 6, while carrying the current collector 1, a first slurry is applied to the current collector 1 arranged on roller 50 using die coater 60a, and thereby first coating layer 2x is formed (first coating layer forming step). Next, while carrying the current collector 1, a second slurry is applied to the first coating layer 2x arranged on the roller 50 using die coater 60b, and thereby second coating layer 3x is formed (second coating layer forming step). After that, although not illustrated, the first coating layer and the second coating layer are dried to from a first electrode layer and a second electrode layer (drying step).

(1) First Coating Layer Forming Step

The first coating layer forming step is a step of forming a first coating layer by coating the current collector with a first slurry. The first slurry contains at least an active material and a dispersion medium. In some embodiments, the first slurry contains at least one of a conductive material and a binder.

In some embodiments, the proportion (weight %) of the binder in the solid content of the first slurry is more than the proportion (weight %) of the binder in the solid content of the second slurry described later. The proportion (weight %) of the binder in the solid content of the first slurry is regarded as C₁′, and the proportion (weight %) of the binder in the solid content of the second slurry is regarded as C₂′. The rate of C₁′ with respect to C₂′, which is C₁′/C₂′ is, for example, 3 or more, and may be 5 or more. Meanwhile, the C₁′/C₂′ is, for example, 10 or less. Incidentally, the relation between C₁′ and C₂′ may be the same as the relation between the C₁ and C₂ described above.

There are no particular limitations on the method for applying the first slurry to the current collector, and examples thereof may include a method using a die coater such as a slit die coater.

(2) Second Coating Layer Forming Step

The second coating layer forming step is a step of forming a second coating layer by coating the first coating layer with a second slurry. The second slurry contains at least an active material and a dispersion medium. In some embodiments, the second slurry contains at least one of a conductive material and a binder.

There are no particular limitations on the method for applying the second slurry to the first coating layer, and examples thereof may include a method using a die coater such as a slit die coater.

For example, the first direction D₁ in FIG. 1A is regarded as a carrying direction of the current collector 1 in FIG. 6. In this case, the structure shown in FIG. 1B can be formed by, for example, adjusting the timing of starting to apply the second slurry by the die coater 60b in FIG. 6. Also, in the second direction D₂, in order to form the same structure as that shown in FIG. 1B, for example, a method of making the width (length in the second direction D₂) of a die head of the die coater 60b in FIG. 6 smaller than the width of a die head of the die coater 60a, may be adopted.

For example, the first direction D₁ in FIG. 4A is regarded as a carrying direction of the current collector 1 in FIG. 6. In this case, the structure shown in FIG. 4B can be formed by, for example, increasing the coating amount of the slurry of the die coater 60a in FIG. 6 temporarily in the end surface. Also, in the second direction D₂, in order to form the same structure as that shown in FIG. 4B, for example, a method of making the coating amount of slurry in the end part of the width direction of the die head more than the coating amount of slurry in the central part, may be adopted. Also, in order to form the protrusion P, a die coater may be used separately.

(3) Drying Step

The drying step is a step of drying the first coating layer and the second coating layer to form the first electrode layer and the second electrode layer. There are no particular limitations on the method for drying and conditions for drying, and conventionally known methods and conventionally known conditions may be adopted.

B. Battery

The battery in the present disclosure includes the electrode body described in “A. Electrode body” above.

According to the present disclosure, the electrode body described above is used, and thus occurrence of defect in an end surface of an electrode layer is inhibited in the battery.

FIG. 7 is a schematic cross-sectional view exemplifying the battery in the present disclosure. Battery 100 shown in FIG. 7 includes electrode body 10A, electrode body 10B, and electrode body 10C. At least one of the electrode body 10A, the electrode body 10B, and the electrode body 10C is the electrode body described in “A. Electrode body” above.

The electrode body 10A includes current collector 11 and cathode layer 12 arranged on the current collector 11. The current collector 11 in the electrode body 10A works as a cathode current collector. Also, the electrode body 10B includes current collector 11, cathode layer 12 arranged on one surface of the current collector 11, and anode layer 13 arranged on the other surface of the current collector 11. The anode layer 13 in the electrode body 10B and the cathode layer 12 in the electrode body 10A are arranged to face to each other interposing separator 14. Also, the electrode body 10C includes current collector 11, and anode layer 13 arranged on the current collector 11. The current collector 11 in the electrode body 10C works as an anode current collector. Also, the anode layer 13 in the electrode body 10C and the cathode layer 12 in the electrode body 10B are arranged to face to each other interposing the separator 14.

The battery in the present disclosure may include just one of the electrode body described in “A. Electrode body” above, and may include plurality thereof. The battery in the present disclosure may include a separator and a liquid electrolyte. There are no particular limitations on the kind of the separator and the liquid electrolyte, and conventionally known separators and conventionally known liquid electrolytes may be used. Also, the battery in the present disclosure may contain a solid electrolyte such as a gel electrolyte and a polymer electrolyte.

The kind of the battery in the present disclosure is not particularly limited, and examples thereof may include a lithium ion secondary battery. Examples of the applications of the battery may include a power source for vehicles such as hybrid electric vehicles (HEV), plug-in hybrid electric vehicles (PHEV), battery electric vehicles (BEV), gasoline-fueled automobiles and diesel powered automobiles. In some embodiments, the electrode body is used as a power source for driving hybrid electric vehicles (HEV), plug-in hybrid electric vehicles (PHEV), and battery electric vehicles (BEV). Also, the battery in the present disclosure may be used as a power source for moving bodies other than vehicles (such as rail road transportation, vessel and airplane), and may be used as a power source for electronic products such as information processing equipment.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### REFERENCE SINGS LIST

1 current collector
2 first electrode layer
3 second electrode layer
10 electrode body
100 battery

What is claimed is:

1. An electrode body to be used for a battery, the electrode body comprising:
a current collector and an electrode layer, wherein
the electrode layer includes layers in the order of a first electrode layer and a second electrode layer from the current collector side in a thickness direction;
the first electrode layer includes an end surface A, and the second electrode layer includes an end surface B;
in a cross-sectional view in the thickness direction, the end surface A includes an end part A₁ in the current collector side, and an end part A₂ in the second electrode layer side, and the end surface B includes an end part B₁ in the first electrode layer side, and an end part B₂ in an opposite side to the first electrode layer;
the end surface A includes, in a vertical direction to the thickness direction, a first inclination part in which the end part A₁ protrudes from the end part A₂; and
when the electrode body is viewed from the thickness direction, an entire outer periphery of the second electrode layer is arranged inside an entire outer periphery of the first electrode layer.

2. The electrode body according to claim 1, wherein
the end surface B includes a second inclination part in which the end part B₁ protrudes from the end part B₂ in the vertical direction to the thickness direction; and
in the cross-sectional view of the thickness direction, the first inclination part is arranged outside the second inclination part.

3. The electrode body according to claim 2, wherein, when the electrode body is viewed from the thickness direction, the first inclination part is arranged along with the entire outer periphery of the first electrode layer, and the second inclination part is arranged along with the entire outer periphery of the second electrode layer.

4. The electrode body according to claim 2, wherein the electrode body includes an exposed part where the first electrode layer is exposed from the second electrode layer, since the end part A₂ protrudes from the end part B₁ in the vertical direction to the thickness direction.

5. The electrode body according to claim 4, wherein, when the electrode body is viewed from the thickness direction, the exposed part is arranged along with the entire outer periphery of the first electrode layer interposing the first inclination part.

6. The electrode body according to claim 1, wherein
the end part A₂ in the end surface A is a tip T₁ of a protrusion that extends in the thickness direction; and
in the cross-sectional view of the thickness direction, an end part B₃ corresponding to the outer periphery of the second electrode layer is arranged inside the tip T₁.

7. The electrode body according to claim 6, wherein, when the electrode body is viewed from the thickness direction, the entire outer periphery of the second electrode layer is arranged inside the entire periphery of the tip T₁.

8. The electrode body according to claim 1, wherein a thickness of the second electrode layer is larger than a thickness of the first electrode layer.

9. The electrode body according to claim 1, wherein a thickness of the electrode layer is 200 μm or more.

10. The electrode body according to claim 1, wherein
each of the first electrode layer and the second electrode layer contains a binder; and
a proportion of the binder in the first electrode layer is more than a proportion of the binder in the second electrode layer.

11. A battery including the electrode body according to claim 1.
